(19) United States
(12) Patent Application Publication
(10) Pub. No.: US 2007/0202391 A1
(43) Pub. Date: Aug. 30, 2007

(54) POROUS CARBON ELECTRODE, IN PARTICULAR FOR A FUEL CELL, AND PROCESS FOR MANUFACTURE THREOF

(75) Inventor: Ralph Greiner, Leonberg (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/679,909

(22) Filed: Feb. 28, 2007

(30) Foreign Application Priority Data
Feb. 28, 2006 (DE) 10 2006 009 567.7

(51) Int. Cl. H01M 4/96; H01M 4/88

(52) U.S. Cl. 429/44; 502/101

(57) ABSTRACT

A porous carbon electrode as well as a process for manufacture thereof enables large freedom in design with respect to shape and porosity of the electrode. The process includes these steps: applying a layer of carbon particles upon a target surface; radiating of a selected part of the layer, corresponding to the cross section of the electrode, with a beam of energy or with a stream of liquid, so that the particles in the selected part are joined or bonded to their respective neighbors, wherein micropores remain between the neighbors; repeating the steps of applying and radiating for a plurality of layers, so that the joined or bonded parts of the adjacent layers are bonded, in order to produce an electrode.

### BACKGROUND OF THE INVENTION

1. Field of the Invention

The invention concerns a porous carbon electrode, in particular for a fuel cell, and a process for the manufacture thereof.

2. Description of the Related Art

Electrodes and processes of this type are generally known as evidenced by DE 19958959 A1 and DE 19938822 A1.

Generally porous carbon electrodes are produced by first producing a paste of carbon particles and binders, then pressing this paste into the shape of an electrode, then drying the pressed shape or, as the case may be, firing or sintering and, in certain cases, follow-up machining.

The requirement to mold or shape limits the ability to rapidly provide a large variety of designs. Besides this, the binder completely blankets the individual particles, so that a required porosity can only be achieved to a limited degree by incorporation of porous particles.

It is thus the task of the present invention to provide a porous carbon electrode as well as a process for manufacture thereof, which permits great freedom in design with respect to shape and porosity of the electrode.

### SUMMARY OF THE INVENTION

This task is solved by a porous electrode, in particular for a fuel cell, which comprises carbon particles, which particles are interconnected by being joined to their respective neighbors, such that micropores are provided between neighboring particles, that is, pores with a diameter in the micrometer range.

In contrast to known electrodes, in the present invention pores exist between adjacent particles instead of only within the carbon particles joined by the binder. As described in greater detail in the following, the size of the pores is adjustable in accordance with the inventive process, from which a greater freedom of design results.

### DETAILED DESCRIPTION OF THE INVENTION

The inventive process for manufacture of the porous electrodes is a so-called rapid process, as known for example from DE 102004003485 A1. For this, particles with diameters in the micrometer range are employed, between which—depending on the type of joining—hollow spaces or pores are formed, likewise with diameters in the micrometer range.

Basically any type of carbon particle is suitable for use in the inventive process, and therewith for the porous electrode, and in particular carbon black, activated carbon, graphite, novolac, carbon aerogels or carbon xerogel particles. Likewise, composites with other materials, in particular conductive materials, would suitable, so long as the resulting conductivity of the electrode is sufficient for the intended purpose. In particular, the carbon particles can be coated with other materials, for example with catalysts in the case of the embodiment as a fuel cell electrode. Particles with catalyst coatings are preferably employed near the outer surface of the electrolyte of the fuel cell. Suitable coating processes include, for example, the fluidized bed process. Of further advantage is a gradient of the porosity, in particular in the case of a fuel cell electrode embodiment. The formation of such a gradient will be described in the following with reference to the inventive process.

One particularly advantageous porosity gradient has initially larger pores between the particles, the size of which continuously decreases in the process direction of the electrode. The terminal particle layer with the smallest porosity carries supplementally applied, for example pressed-on, catalysts. The larger pores ensure a sufficient gas uptake out of the reaction gas stream, while the smaller pores ensure an even distribution of the reaction gas along the catalyst (catalytic reactor) layer. The term “reaction gas” includes both the exhaust gas (for example H₂ or a H₂-containing gas) and the oxidant (for example O₂ or an O₂ containing gas, for example air).

It is particularly advantageous when the porosity gradient is formed not only perpendicular to the gas stream, but rather exhibits also a parallel component. That is, the large pores at the inlet of the gas channel are smaller than the large pores at the end thereof. Accordingly, the size of the deeper lying pores increases. Thereby the gas loss (that is, the enrichment of the reaction gas stream with reaction gas and the enrichment with reaction products, for example water) in the flow or sequence of the gas channel are equalized or evened out, so that an optimal supply or, as the case may be, removal of reaction starting materials and reaction end products to or, as the case may be, from the reactive centers is ensured. This is basically the case when a essentially even concentration of reaction gas exists along the catalyst layer. This gradient of the porosity can also be referred to as the gradient of the surface roughness.

The task of providing a process for manufacture of a porous electrode, in particular for a fuel cell, is inventively solved with respect to the process by the steps:

applying a layer of particles upon a target surface,

radiating a selected part of the layer, corresponding to the cross section of the electrode, with a beam of energy or with a stream of liquid, so that the particles in the selected part are joined or bonded to their respective neighbors, wherein micropores remain between the neighbors,

repeating the steps of applying and radiating for a plurality of layers, so that the joined parts of the adjacent layers are bonded, in order to produce an electrode, wherein carbon particles are employed.

Herein the term electrode is intended to encompass any conductive object. It is known to produce this type of object from metal particles using the laser sintering rapid prototyping process. These conductive objects have however until now not been employed as electrodes, but rather as particularly stable metallic prototypes.

The employment of carbon particles in this type of generative process has likewise not yet been known.

The beam of energy can be any type, for example an electrode beam or IR-beam, preferably a laser beam, as long as the energy input into the particle layer is only sufficient to bring about a bonding of the particles. Accordingly the particles in the area being irradiated may not melt completely. A sintering or an energetic initiation of a chemical reaction can likewise suffice.

When using a liquid stream at least a component of the particles must be soluble in the liquid, or a reaction must be initiated as a consequence of the reaction with the liquid, bringing about a bonding of the particles in the area of application of the liquid. The term “liquid stream” includes not only a continuous stream, but rather in particular also individual droplets. In a case of spraying with a liquid the particles are dissolved on their surface or the liquid contains a binder. The liquid evaporates and leaves behind a bridge joining adjacent particles. Between the bridges joining adjacent particles hollow spaces or pores remain. The size is adjustable by the strength of the radiation or spraying (energy input or as the case may be volume of liquid).

As the liquid for the three dimensional printing of a porous electrode, a non-polar solvent, in which a carbon based binder, for example tar, is dissolved is suitable as a non-polar solvent. Suitable non-polar solvents are, for example, aromatics, in particular toluol or alkanes such as pentane, since they dissolve tars in sufficient amounts and remain suitable for printing.

The carbon based binder can however also contain fluoridated polymers, for example PTFE, or ionomers, for example Nafion. Their concentration can be varied alternatively or in addition to the droplet volumes. This enables the formation of gradients of the hydrophobicity both between different particle layers as well as within one layer. Particularly advantageous is a hydrophobic gradient, which decreases from the catalyst layer and therewith automatically repels or keeps away the resulting water. It is conceivable to adjust a hydrophobic maximum just below the catalyst layer. This ensures that a certain minimum amount of water always remains on the catalyst layer, thereby rendering it damp, and that water runs off through the electrode only after achieving a threshold amount beyond the hydrophobic maximum.

In the inventive process it is particularly advantageous when the radiation strength or intensity is varied in such a manner that the width of the area joining between adjacent particles as a result of the radiation varies, and thereby also the porosity.

This allows the formation of porosity gradients with one or even multiple directions of preference, this would be particularly advantageous in the case of fuel cell electrodes and as described above.

In the following, the inventive electrode and the inventive process will be described in greater detail on the basis of three illustrative examples.

According to a first illustrative example, a layer of carbon particles, surface coated with a tar based binder, are applied upon a target surface. A selected part of the layer, corresponding to a cross section of the electrode, is radiated with a focused laser beam. The tar is carbonized and joins the particles in the selected area with their respective neighbors, as a result of which micropores remain between the neighbors. These steps are repeated for a number of layers, so that the joined parts of the adjacent layers are bonded in order to form the electrode.

According to a second illustrative example a layer of carbon particles is applied onto a target surface. A selected part of the layer, corresponding to a cross section of the electrode, is printed with pentane containing dissolved tar. The pentane rapidly evaporates and the tar joins the particles in the selected area with their adjacent neighbors, whereupon micropores remain between the neighbors. These steps are repeated for a plurality of layers, such that the joined parts of the adjacent layers bond, in order to form an electrode.

According to a third illustrative embodiment a fuel cell electrode is produced analogously to the second illustrative embodiment. Therein the gas channeling side of the electrode is produced first. For this, large pores are required. Accordingly, comparatively little binder liquid is printed, whereby comparatively small linking bridges between the particles result. Subsequently the volume of the binder liquid droplets are reduced from the side of the gas inlet side, so that the width of the joining or linking bridges diminish parallel to the gas channel, while the pore size respectively increases parallel to the gas channel. For the subsequent particle layers the volume of the binder liquid droplets is continuously increased in volume, so that a continuous increase in the width of the linking bridges, and respectively a reduction in the pore size, results both perpendicular as well as parallel to the gas flow through the gas channel. The catalyst layer is printed upon the final particle layer. The finished electrode can also be fired for increasing the stability and for improving conductivity, whereby the tar carbonizes the linking bridges. In similar manner the carbonizing can also occur by application of electric current and resistance heating of the electrode.

The inventive porous electrode and the inventive process for manufacture thereof characterize themselves in the embodiments of the above described examples as particularly suited for fuel cells.

Thereby in particular a distinct improvement in gas channeling, in particular the evening out, can be achieved by the pore gradients.

The invention is not only limited to the illustrated embodiments, but rather can be broadly applied.

Thus for example catalysts can be printed, besides only at the top layer, also for example in other layers, in particular layers close to the electrolyte. The printing of a particle layer with varying solubilities—for example binder solubility and dispersed catalysts—is no problem with modern multiple print heads. Besides this, the catalyst load or concentration in the particle layers can likewise exhibit a gradient, preferably in counter-current to the pore size.

Now that the invention has been described, I claim:

1. A porous electrode which contains carbon particles, wherein the carbon particles are joined to their respective neighbors, wherein micropores exist between the neighbors.

2. The porous electrode according to claim 1, wherein the carbon particles are selected from carbon black, activated carbon, graphite, novolac, carbon aerogel or carbon xerogel particles.

3. The porous electrode according to claim 1, wherein the carbon particles are coated particles.

4. The porous electrode according to claim 1, wherein the porosity exhibits a gradient.

5. The porous electrode according to claim 1 wherein the surface roughness exhibits a gradient.

6. A process for manufacture of an electrode, in particular for a fuel cell, including the following steps:
applying a layer comprising carbon particles upon a target surface,
radiating a selected part of the layer, corresponding to the cross section of the electrode, with a beam of energy or a stream of liquid, so that the particles become joined to their neighbors in the selected part, whereby micropores are formed between the neighbors,
repeating the steps of applying and radiating for a plurality of layers, so that the joined parts of the adjacent layers bond to each other, in order to form an electrode.

7. The process according to claim 6, wherein as the liquid a non-polar solvent in which tar is dissolved is employed.

8. The process according to claim 6, wherein the beam strength is varied, so that the width of the joined areas between adjacent particles formed as a consequence of radiation and likewise the porosity is varied.

9. A multiphase material system for use in 3D-printing including fixed particles and a liquid,
wherein at least parts of the particles exhibit the characteristics of forming permanent bonds with adjacent particles upon contacting with a liquid,
wherein the particles are carbon particles and that the liquid is a non-polar solvent in which tar is dissolved.

10. A porous electrode as in claim 1, wherein said porous electrode is a fuel cell electrode.

11. A porous electrode as in claim 1, wherein said porous electrode exhibits varying degrees of hydrophobicity.

12. The porous electrode according to claim 3, wherein the coating includes catalysts.

13. The porous electrode according to claim 4, wherein the porosity gradient is oriented diagonally to the surface.
